(19) United States
(12) Patent Application Publication
(10) Pub. No.: US 2010/0140260 A1
(43) Pub. Date: Jun. 10, 2010

(54) Microwave oven

(75) Inventor: Gong-Soo Kim, Suwon-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/457,390

(22) Filed: Jun. 9, 2009

(30) Foreign Application Priority Data
Dec. 4, 2008 (KR) 10-2008-122540

(51) Int. Cl. H05B 6/66

(52) U.S. Cl. 219/715

(57) ABSTRACT

Disclosed is a microwave oven capable of preventing leakage of microwaves by using a plurality of primary switches, a plurality of secondary switches and a plurality of monitor switches. The primary switches are serially connected with each other, the secondary switches are connected in parallel with each other, and the monitor switches are connected in parallel with each other, so that the microwave oven does not operate if a door of the microwave oven is not completely closed.

### CROSS-REFERENCE TO RELATED APPLICATIONS

This application claims the benefit of Korean Patent Application No. 10-2008-0122540, filed on Dec. 4, 2008, in the Korean Intellectual Property Office, the disclosure of which is incorporated herein by reference.

### BACKGROUND

1. Field

The present invention relates to a microwave oven. More particularly, the present invention relates to a microwave oven capable of preventing leakage of microwaves.

2. Description of the Related Art

In general, a microwave oven is used to cook food by irradiating microwaves generated from a magnetron onto the food. As the microwaves are irradiated onto the food, friction heat is generated in the food due to translation of water molecules contained in the food, so that the food is cooked.

Typically, the microwave oven includes a body having a cooking chamber, and a door hinged to the body to open and close the cooking chamber. The microwave oven is divided into a left open/close type and a right open/close type. According to the left open/close type microwave oven, a user opens and closes the door, which is hinged to a left side of the body, by using a left hand. According to a right open/close type microwave oven, a user opens and closes the door, which is hinged to a right side of the body, by using a right hand. A user can select either of the two types.

However, the type of the microwave oven must be changed depending on an installation location of the microwave oven. In detail, the left open/close type microwave oven must be replaced with the right open/close type microwave oven, or vice versa according to the installation places thereof.

### SUMMARY

Accordingly, it is an aspect to provide an interconnection method among a primary switch, a secondary switch and a monitor switch to prevent oscillation of a magnetron when a door of a microwave oven is open.

Additional aspects and/or advantages will be set forth in part in the description which follows and, in part, will be apparent from the description, or may be learned by practice of the invention.

The foregoing and/or other aspects are achieved by providing a microwave oven including a storage chamber; a power supply; a door that opens and closes the storage chamber, a magnetron that generates microwaves in the storage chamber, and a plurality of switches serially connected with each other between the magnetron and the power supply. The switches may be turned on/off according to opening/closing of the door.

The switches may include primary or secondary switches.

The primary or secondary switches may be turned on if the door is closed while being turned off if the door is opened.

Power may be prevented from being provided to the magnetron if one of the primary switches is turned off.

Power may be prevented from being applied to the magnetron if one of the secondary switches is turned off.

The foregoing and/or other aspects may be achieved by providing a microwave oven including a storage chamber; a power supply; a door that opens and closes the storage chamber, a magnetron that generates microwaves in the storage chamber, and a plurality of switches connected in parallel with each other between the magnetron and the power supply. The switches may be turned on/off according to opening/closing of the door.

The switches may include monitor switches.

The monitor switches may be turned off if the door is closed while being turned on if the door is opened.

Power may be prevented from being applied to the magnetron if one of the monitor switches is turned on.

The primary switches, the secondary switches and the monitor switches are installed at the top, bottom, left and right sides of the front surface of the body of the microwave oven. The primary switches, the secondary switches and the monitor switches are serially interconnected or connected in parallel with each other, so that power is prevented from being applied to the magnetron if one of the switches is shorted. Thus, the leakage of microwaves can be prevented.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a microwave oven according to an exemplary embodiment;

FIG. 2 is a plan view illustrating the microwave oven shown in FIG. 1;

FIG. 3 is a perspective view illustrating a state in which a door is separated from a body in a microwave oven according to an exemplary embodiment;

FIG. 4 is an enlarged view illustrating a part of the latch body shown in FIG. 3;

FIG. 5 is a view illustrating a state in which a door of a microwave oven is closed according to an exemplary embodiment; and

FIG. 6 is a circuit diagram illustrating a microwave oven according to an exemplary embodiment of the present invention.

### DETAILED DESCRIPTION OF EMBODIMENT

Reference will now be made in detail to the embodiments, examples of which are illustrated in the accompanying drawings, wherein like reference numerals refer to the like elements throughout. The embodiments are described below to explain the present invention by referring to the figures.

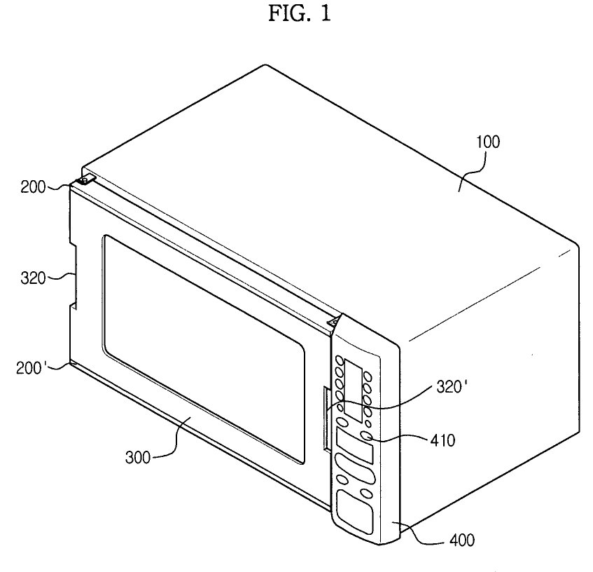

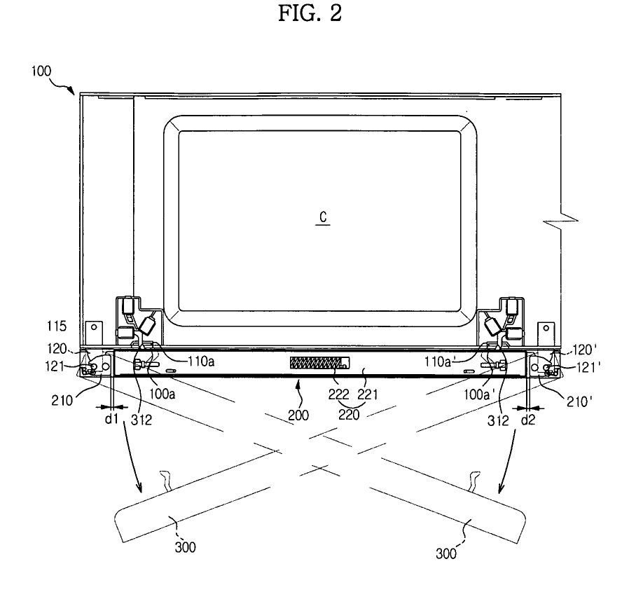

FIG. 1 is a perspective view illustrating a microwave oven according to an exemplary embodiment and FIG. 2 is a plan view illustrating the microwave oven shown in FIG. 1.

As shown in FIGS. 1 and 2, the microwave oven according to the embodiment of the present invention includes a body 100 having a cooking chamber C therein, and a door 300 that opens and closes the front surface of the body 100. A control panel 400 provided with a plurality of manipulation buttons 410 is installed at one side of the door 300 to control various functions of the microwave oven. Knobs 320 and 320′ are installed at left and right sides of the door 300 to open and close the door 300.

Change devices 200 and 200′ are installed at the upper and lower sides of the door 300 to allow the door 300 to be opened and closed in the right or left direction. The change devices 200 and 200′ are symmetrically installed at the upper and lower sides of the door 300. The change device 200 includes a pair of holder members 210 and 210′ coupled with the body 100, and a movement member 220 that interconnects the holder members 210 and 210′.

The holder members 210 and 210′ are coupled with a pair of hinge brackets 120 and 120′ installed at the front surface of the body 100, respectively.

The movement member 220 includes a link member 221 and an elastic member 222 that generates tension at the center portion of the link member 221. The link member 221 forms a predetermined interval d1 between the movement member 220 and the holder member 210, and a predetermined interval d2 between the movement member 220 and the holder member 210′.

The link member 221 is not biased to the right or left side by the elastic member 222 in a state in which the door 300 is closed.

When the door 300 is rotated about the left hinge bracket 120 to open the cooking chamber C, the holder member 210 installed in the opening direction of the door 300 is rotated so that the link member 221 moves toward the holder member 210′. Thus, an interval of (d1+d2) is formed between the holder member 210 and the link member 221 such that the holder member 210 can be rotated, and the link member 221 makes contact with the holder member 210′.

Accordingly, the door 300 is rotated about the hinge bracket 120 installed at the left end of the body 100 to open the cooking chamber C, or the door 300 is rotated about the hinge bracket 120′ installed at the right end of the body 100 to open the cooking chamber C, so that the door 300 can be opened and closed in the right or left direction.

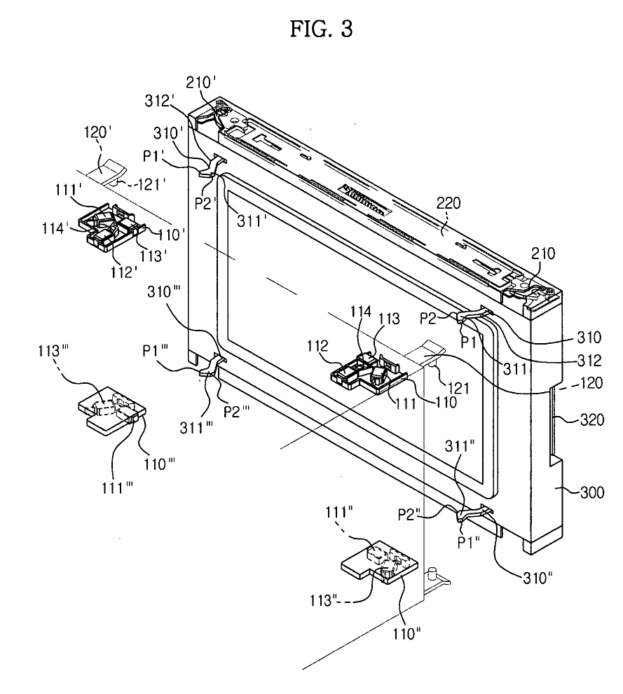

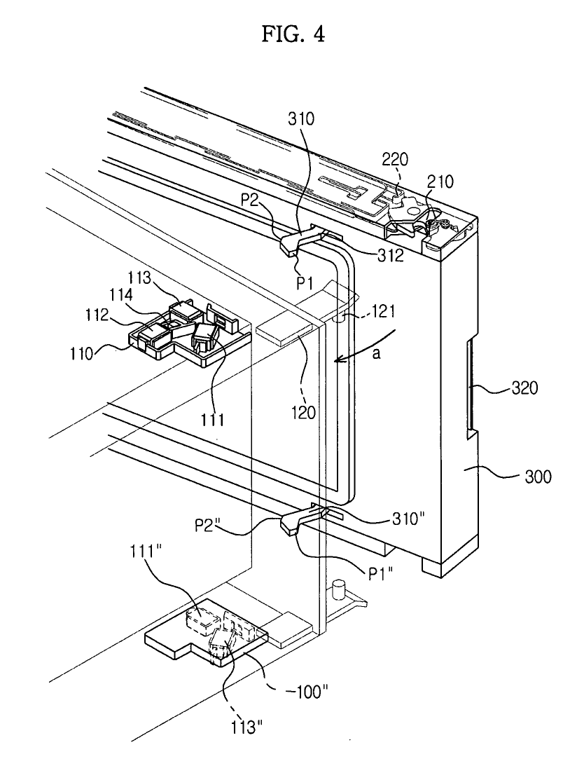

FIG. 3 is a perspective view illustrating a state in which the door is separated from the body in the microwave oven according to the embodiment and FIG. 4 is an enlarged view illustrating a part of the latch body shown in FIG. 3.

As shown in FIGS. 3 and 4, the door 300 includes first to fourth door keys 310, 310′, 310″ and 310′″ that maintain a closed state of the cooking chamber C when the door 300 is closed. Further, the body 100 is provided with a plurality of first to fourth latch bodies 110, 110′, 110″ and 110′″, and the door keys 310, 310′, 310″ and 310′″ are detachably locked with the first to fourth latch bodies 110, 110′, 110″ and 110′″.

The door keys 310, 310′, 310″ and 310′″ are installed at the top, bottom, left and right sides of the door 300, respectively. In detail, the first door key 310 is provided at the left upper end of the door 300, the second door key 310′ is provided at the right upper end of the door 300, the third door key 310″ is provided at the left lower end of the door 300, and the fourth door key 310′″ is provided at the right lower end of the door 300.

The door keys 310, 310′, 310″ and 310′″ are provided with contact sections 311, 311′, 311″ and 311′″ bent in one direction, respectively, so that the door keys 310, 310′, 310″ and 310′″ can be locked with the first to fourth latch bodies 110, 110′, 110″ and 110′″. The contact sections 311, 311′, 311″ and 311′″ are provided with pressing units P1 and P2, P1′ and P2′, P1″ and P2″, and P1′″ and P2′″ to press micro switches 111 to 113, 111′ to 113′, 111″ to 113″ and 111′″ to 113′″, according to opening and closing of the door 300, respectively.

The first latch body 110 is installed at the body 100 while being coupled with the first door key 310, the second latch body 110′ is coupled with the second door key 310′, the third latch body 110″ is coupled with the third door key 310″, and the fourth latch body 110′″ is coupled with the fourth door key 310′″.

In detail, the first to fourth latch bodies 110, 110′, 110″ and 110′″ are symmetrically installed at the top, bottom, left and right sides of the body 100 corresponding to the positions of the door keys 310, 310′, 310″ and 310′″. Unless specially mentioned otherwise, the latch bodies 110′, 110″ and 110′″ are identical to the latch body 110 installed at the left end of the body 100, and detailed description thereof will be omitted.

The first latch body 110 is installed at the left upper end of the body 100 while being fixed to the body using a coupling device such as a screw. The first latch body 110 is formed at the front surface thereof with an insertion port 110a corresponding to the first door key 310 such that the first door key 310 can be inserted into the first latch body 110.

Further, the body 100 is formed at the front surface thereof with a through hole 100a corresponding to the first door key 310 and the insertion port 110a. Further, the insertion port 110a is provided at the inner side thereof with a support section 115, with which the first door key 310 is locked, and a guide section that guides insertion of the first door key 310.

The support section 115 extends from the insertion port 110a to the first latch body 110 to have a predetermined inclination angle. The inclination angle and extension length of the support section 115 are formed to the extent that the micro switch 111 located adjacent to the hinge bracket 120 is not randomly pressed by a user. Thus, when the first door key 310 is inserted into the insertion port 110a, the first door key 310 moves a predetermined distance while being guided by the guide section of the insertion port 110a, and then is locked with the support section 115 by elastic force of a spring.

The first latch body 110 is provided with the three micro switches 111 to 113 to control an operation of the microwave oven by detecting opening and closing of the door 300 according to the insertion of the first door key 310. In detail, the first latch body 110 is provided with the primary switch 111, the monitor switch 112 and the secondary switch 113 to detect the insertion of the first door key 310.

The monitor switch 112 serves as a contact point switch that performs an on/off operation. The monitor switch 112 is provided at a side thereof with a button (not shown) operated by a lever 114. The monitor switch 112 is in an off state when the door 300 is closed and is turned off when the door 300 is opened, so the monitor switch 112 bypasses input voltage by forming an electrical closed loop circuit. Thus, the monitor switch 112 performs a safety function together with the primary and secondary switches 111 and 113.

The primary and secondary switches 111 and 113 are provided at both sides of the monitor switch 112. The primary and secondary switches 111 and 113 are provided at sides thereof with buttons (not shown) operated by the first door key 310.

When the door 300 is closed, the primary and secondary switches 111 and 113 are turned on. In such a state, as a relay is turned on, AC power is supplied to a high voltage unit including a high voltage transformer and a magnetron. Further, when the door 300 of the microwave oven is opened, the primary and secondary switches 111 and 113 always maintain an off state, so that power is not supplied to the high voltage unit including the high voltage transformer and the magnetron.

The second latch body 110′ is installed at the right upper end of the body 100. The second latch body 110′ is provided with the three micro switches 111 ′ to 113′ to control the operation of the microwave oven by detecting the opening and closing of the door 300 according to insertion of the second door key 310′. In detail, the second latch body 110′ is provided with the primary switch 111′, the monitor switch 112′ and the secondary switch 113′ to detect the insertion of the second door key 310′.

The third latch body 110″ is installed at the left lower end of the body 100. The third latch body 110″ is provided with the two micro switches 111″ and 113″ to control the operation of the microwave oven by detecting the opening and closing of the door 300 according to insertion of the third door key 310″. In detail, the third latch body 110″ is provided with the primary switch 111″ and the secondary switch 113″ to detect the insertion of the third door key 310″.

The fourth latch body 110′″ is installed at the right lower end of the body 100. The fourth latch body 110′″ is provided with the two micro switches 111′″ and 113′″ to control the operation of the microwave oven by detecting the opening and closing of the door 300 according to insertion of the fourth door key 310′″. In detail, the fourth latch body 110′″ is provided with the primary switch 111′″ and the secondary switch 113′″ to detect the insertion of the fourth door key 310′″.

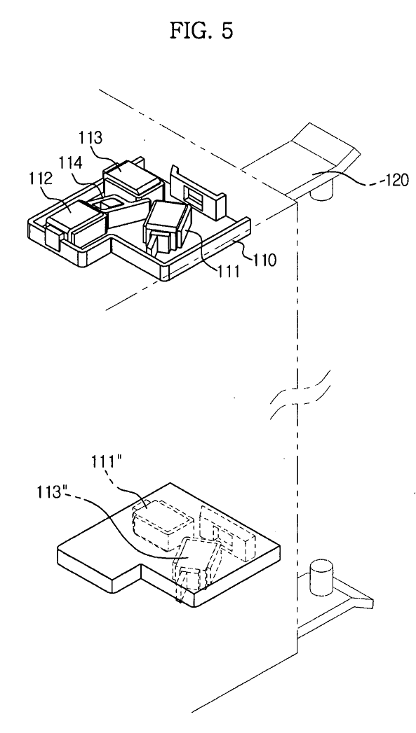

FIG. 5 is a view illustrating a state in which the door of the microwave oven is closed.

As a user pushes the door 300 in the direction′ a′ to close the door 300 in the left direction, the first and third door keys 310 and 310″ are inserted into the first and third latch bodies 110 and 110″ through the insertion ports 110a and 110a′, so that the first and third door keys 310 and 310″ are locked with the first and third latch bodies 110 and 110″. At this time, the first and third door keys 310 and 310″ move along the guide section of the first and third latch bodies 110 and 110″, and then are locked with the support section 115 by the elastic force of the spring installed in the door 300. Thus, the pressing units P1 and P2 of the first door key 310 press the buttons of the monitor switch 112 and the primary and secondary switches 111 and 113 of the first latch body 110, and simultaneously the pressing units P1″ and P2″ of the third door key 310″ press buttons (not shown) of the primary and secondary switches 111″ and 113″ of the third latch body 110″, so that microwaves can be supplied to the cooking chamber C.

Then, as a user pulls the door 300 in the direction reverse to the direction ‘a’ to open the door 300 in the left direction, the first and third door keys 310 and 310″ move out of the first and third latch bodies 110 and 110″ through the insertion ports 110a and 110a′. Thus, the buttons of the monitor switch 112 and the primary and secondary switches 111 and 113 pressed by the pressing units P1 and P2 of the first door key 310 return to the original position, and the buttons of the primary and secondary switches 111″ and 113″ pressed by the pressing units P1″ and P2″ of the third door key 310″ return to the original position, so that the microwaves can be prevented from being supplied to the cooking chamber C.

Since the primary switch 111 of the first latch body 110 is serially connected with the primary switch 111″ of the third latch body 110″, one of the first and third door keys 310 and 310″ is detached from the third latch body 110″, so that opening of the door 300 can be detected and simultaneously the microwaves can be prevented from being supplied to the cooking chamber C.

Further, when the door 300 is opened or closed in the right direction, the second and fourth door keys 310′ and 310′″ and the second and fourth latch bodies 110′ and 110′″ operate similarly to the first and third door keys 310 and 310″ and the first and third latch bodies 110 and 110″. In detail, the second and fourth door keys 310′ and 310′″ press buttons (not shown) of the monitor switch 112′ and the primary and secondary switches 111′ and 113′ and buttons (not shown) of the primary and secondary switches 111′″ and 113′″, respectively, or allow the pressed buttons to return to the original position. Thus, the microwaves can be supplied and prevented from being supplied to the cooking chamber C.

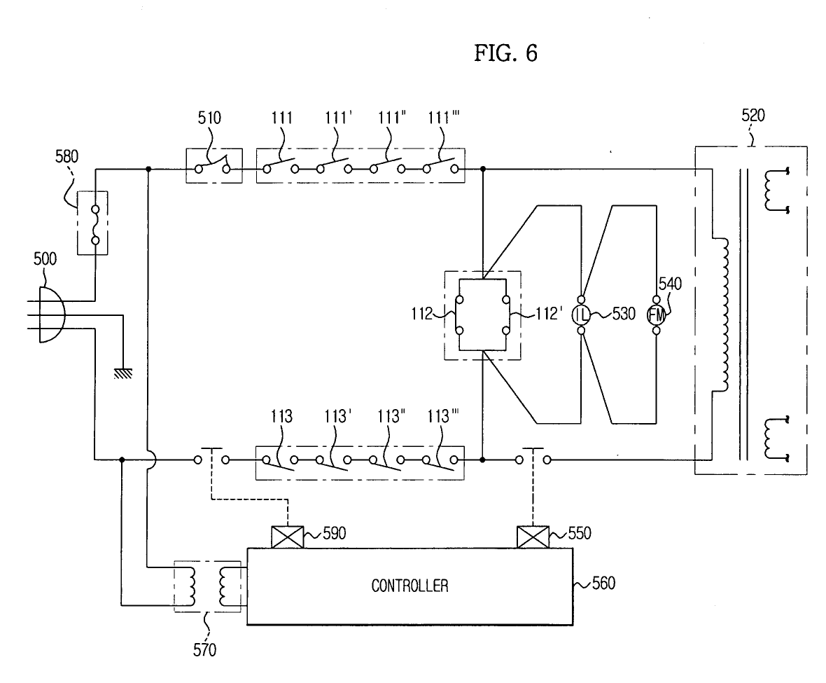

FIG. 6 is a circuit diagram illustrating the microwave oven according to one embodiment of the present invention.

As shown in FIG. 6, the microwave oven includes the monitor switches 112 to 112′, the primary switches 111 to 111′″ and the second switches 113 to 113′″, a controller 560, a start relay 590, a fan motor 540, an output control relay 550, and a high voltage transformer 520. The monitor switches 112 to 112″ are turned off when the door 300 of the microwave oven is closed relative to the body 100. The primary switches 111 to 111′″ and the second switches 113 to 113′″ are turned on when the monitor switches 112 to 112″ are turned off. The controller 560 controls the operation of the microwave oven using driving power, which is input through a low voltage transformer 570, according to a function selection signal input from the control panel 400. The start relay 590 turns on a start relay switch in response to a control signal of the controller 560. The fan motor 540 cools a machine room and the cooking chamber C by using constant power received from a commercial power supply 500 as the start relay switch is turned on. The output control relay 550 turns on/off an output control relay-switch through a relay contact operation in response to the control signal of the controller 560. The high voltage transformer 520 boosts primary voltage to secondary voltage based on a turn ratio of a coil in response to the contact operation the output control relay switch being turned on.

Further, a magnetron switch 510 is connected between the commercial power supply 500 and the primary switches 111 to 111′″ to be turned off if the temperature generated from the magnetron is equal to or greater than the predetermined temperature. Further, a fuse 580 is installed between the commercial power supply 500 and the magnetron switch 510 to prevent the microwave oven from malfunctioning due to an abnormal operation of each safety switch.

Hereinafter, the operation of the microwave oven will be described by employing the case of pushing the door 300 in the direction ‘a’ to close the door 300 in the left direction, as shown in FIG. 5, as an example.

First, the door 300 of the microwave oven receiving commercial voltage 110V or 220V is opened, food is put on a tray in the inner lower end of the cooking chamber C, and then the door 300 is closed. Then, the monitor switch 112 is turned off through a switching operation and simultaneously the primary switches 111 and 111″ and the second switches 113 and 113″ are turned on.

In detail, the monitor switch 112′ installed at the right side of the front surface of the microwave oven is in the off state because the monitor switch 112′ has been pressed by the door key 310′, and the primary switches 111 and 111″ and the second switches 113 and 113″ are in the on state because the they have been pressed by the door keys 310′ and 310′″.

Meanwhile, as a user selects a cooking function for the food by manipulating a manipulation panel, a predetermined signal is input to the controller 560 from the manipulation panel. Then, the controller 560 determines that the door 300 is closed to apply a predetermined signal to the start relay 590. Further, the output control relay switch is turned on through a relay operation of the output control relay 550 in response to the control signal of the controller 560, and the commercial voltage is boosted to high voltage through the high voltage transformer 520 and then is input to a high voltage rectifier including a combination of a high voltage capacitor C (not shown) and a high voltage diode D (not shown) connected with the secondary coil of the high voltage transformer 520. The high voltage rectified through the high voltage rectifier is supplied to the magnetron to generate magnetron microwaves. The microwave is used to cook the food through a wave guide.

Meanwhile, since the microwave oven cooks the food at the high temperature, electric parts and other parts must have high heat resisting property. Further, the primary switches 111 to 111′″, the second switches 113 to 113′″ and the monitor switches 112 and 112′ are provided to prevent the microwave oven from malfunctioning in a state in which the door 300 is not completely closed. Hereinafter, functions of each switch will be described.

The primary switches 111 to 111′″ are installed at the top, bottom, left and right sides of the front surface of the body 100 of the microwave oven while being serially connected with each other in a circuit configuration. When the door 300 is closed, the four primary switches 111 to 111′″ are turned on so that the power is applied to the magnetron of the microwave oven. According to the above configuration, the power is not applied to the magnetron of the microwave oven if one of the four primary switches 111 to 111′″ is not mechanically pressed. In detail, the fact that one of the four primary switches 111 to 111′″ is not pressed represents that the door 300 is not completely closed. Thus, the four primary switches 111 to 111′″ are serially connected with each other to prevent the microwave from being leaked out of the microwave oven by stopping driving of the magnetron when the door 300 is opened.

The secondary switches 113 to 113′″ are installed at the top, bottom, left and right sides of the front surface of the body 100 of the microwave oven while being serially connected with each other in a circuit configuration, similarly to the primary switches 111 to 111′″. When the door 300 is closed, the secondary switches 113 to 113′″ are turned on so that the power is applied to the magnetron of the microwave oven. According to the above configuration, the power is not applied to the magnetron of the microwave oven if one of the four secondary switches 113 to 113′″ is not mechanically pressed. Further, the secondary switches 113 to 113′″ can also serve as door open switches. In detail, a microcomputer determines that the door 300 is closed by detecting that the secondary switches 113 to 113′″ are turned on, and controls load-driving relays in the driving circuit of the microwave oven only when the door 300 is in a closed state.

The monitor switches 112 and 112′ are installed at the right and left sides of the front upper end of the body 100 while being connected in parallel with each other in a circuit configuration. When the door 300 is closed, the monitor switches 112 and 112′ are turned off so that the power is applied to the magnetron of the microwave oven later. According to the above configuration, the monitor switches 112 and 112′ are turned on to form a closed circuit if one of the two monitor switches 112 and 112′ is not mechanically pressed, so that the power is not applied to the driving circuit of the microwave oven.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A microwave oven comprising:
a storage chamber;
a power supply;
a door that opens and closes the storage chamber;
a magnetron that generates microwaves in the storage chamber; and
a plurality of switches serially connected with each other between the magnetron and the power supply,
wherein the switches are turned on/off according to opening/closing of the door.

2. The microwave oven of claim 1, wherein the switches comprise primary or secondary switches.

3. The microwave oven of claim 2, wherein the primary or secondary switches are turned on if the door is closed while being turned off if the door is opened.

4. The microwave oven of claim 3, wherein power is prevented from being applied to the magnetron if one of the primary switches is turned off.

5. The microwave oven of claim 3, wherein the power is prevented from being applied to the magnetron if one of the secondary switches is turned off.

6. A microwave oven comprising:
a storage chamber;
a power supply;
a door that opens and closes the storage chamber;
a magnetron that generates microwaves in the storage chamber; and
a plurality of switches connected in parallel with each other between the magnetron and the power supply,
wherein the switches are turned on/off according to opening/closing of the door.

7. The microwave oven of claim 6, wherein the switches comprise monitor switches.

8. The microwave oven of claim 7, wherein the monitor switches are turned off if the door is closed while being turned on if the door is opened.

9. The microwave oven of claim 8, wherein power is prevented from being applied to the magnetron if one of the monitor switches is turned on.

10. A microwave oven comprising:
a power supply;
a door;
a magnetron; and
a plurality of switches serially connected with each other between the magnetron and the power supply,
wherein the switches are turned on/off according to opening/closing of the door.
